(19) United States
(12) Patent Application Publication
(10) Pub. No.: US 2024/0394546 A1
(43) Pub. Date: Nov. 28, 2024

(54) BACKBONE NETWORK LEARNING METHOD AND SYSTEM BASED ON SELF-SUPERVISED LEARNING AND MULTI-HEAD FOR VISUAL INTELLIGENCE

(71) Applicant: Korea Electronics Technology Institute, Seongnam-si (KR)

(72) Inventors: Choong Sang CHO, Seongnam-si (KR); Young Han LEE, Seongnam-si (KR); Ju Hong YOON, Hwaseong-si (KR); Gui Sik KIM, Seongnam-si (KR)

(73) Assignee: Korea Electronics Technology Institute, Seongnam-si (KR)

(21) Appl. No.: 18/225,304

(22) Filed: Jul. 24, 2023

(30) Foreign Application Priority Data
May 26, 2023 (KR) 10-2023-0068170

(51) Int. Cl. G06N 3/0895

(52) U.S. Cl. CPC G06N 3/0895

(57) ABSTRACT

There is provided a learning method and system of a backbone network for visual intelligence based on self-supervised learning and multi-head. A network learning system according to an embodiment generates a plurality of first modified vectors by modifying a first feature vector outputted from a teacher network, generates a plurality of second modified vectors by modifying a second feature vector outputted from a student network, calculates a loss by using the first modified vectors and the second modified vectors, and optimizes parameters of the student network. Accordingly, the effect of learning by knowledge distillation may be enhanced by training the backbone network for visual intelligence like group learning is performed by various teacher networks and student networks.

### CROSS-REFERENCE TO RELATED APPLICATION(S) AND CLAIM OF PRIORITY

This application is based on and claims priority under 35 U.S.C. § 119 to Korean Patent Application No. 10-2023-0068170, filed on May 26, 2023, in the Korean Intellectual Property Office, the disclosure of which is herein incorporated by reference in its entirety.

### BACKGROUND

### Field

The disclosure relates to deep-learning network learning, and more particularly, to a method for training a backbone network which extracts features from an image in a self-supervised learning method.

### Description of Related Art

Knowledge distillation refers to a learning method which transfers knowledge from a teacher network, which is an already well-trained network, to a student network, which is a small network intending to use the knowledge, thereby achieving similar high performance.

By applying knowledge distillation to a backbone network which is a basis of visual intelligence, the backbone network can perform self-supervised learning. To achieve this, learning is performed in such a manner that a feature vector extracted from a teacher backbone network and a feature vector extracted from a student backbone network are made to be equal with respect to the same image.

However, the effect of learning by the backbone network by knowledge distillation may be lower than expected.

### SUMMARY

The disclosure has been developed in order to solve the above-described problems, and an object of the disclosure is to provide, as a solution for enhancing the effect of learning by a backbone network by knowledge distillation, a learning method of a backbone network for visual intelligence, which increases a feature vector extracted from a teacher network and a student network and calculates a loss.

According to an embodiment of the disclosure to achieve the above-described object, a network learning system may include: a first augmentation unit configured to generate a plurality of first modified vectors by modifying a first feature vector outputted from a teacher network; a second augmentation unit configured to generate a plurality of second modified vectors by modifying a second feature vector outputted from a student network; a loss calculation unit configured to calculate a loss by using the first modified vectors and the second modified vectors; and an optimization unit configured to optimize parameters of the student network based on the calculated loss.

The first augmentation unit may include first modifiers configured to generate the plurality of first modified vectors by applying different modification methods to the first feature vector, the second augmentation unit may include second modifiers configured to generate the plurality of second modified vectors by applying different modification methods to the second feature vector, and the first modifiers and the second modifiers may make pairs and apply a same modification method.

The first modifiers may generate the first modified vectors by masking a part of feature data constituting the first feature vector with zero, and the second modifiers may generate the second modified vectors by masking a part of feature data constituting the second feature vector with zero.

The first modifiers and the second modifiers may mask a number of pieces of feature data determined according to pre-set masking ratios with zero, respectively.

The masking ratios may be configured by a user or randomly configured, and positions of feature data to be masked with zero may be randomly determined.

The first modifier may generate a first weight vector from the first modified vector, may generate a second weight vector from the first feature vector, may generate a final weight vector by adding up the first weight vector and the second weight vector, and may generate a final first modified vector by calculating the first feature vector and the final weight vector, and the second modifier may generate a first weight vector from the second modified vector, may generate a second weight vector from the second feature vector, may generate a final weight vector by adding up the first weight vector and the second weight vector, and may generate a final second modified vector by calculating the second feature vector and the final weight vector.

The loss calculation unit may calculate an average of differences between the first modified vectors and the second modified vectors as a loss.

The loss calculation unit may further calculate an average of differences between a first modified vector having smallest modification among the first modified vectors, and the first modified vectors, as a loss.

The network learning system may further include: a first dimension conversion unit configured to convert dimensions of the first modified vectors generated in the first augmentation unit; and a second dimension conversion unit configured to convert dimensions of the second modified vectors generated in the second augmentation unit.

According to another aspect of the disclosure, there is provided a network learning method including: a first augmentation step of generating a plurality of first modified vectors by modifying a first feature vector outputted from a teacher network; a second augmentation step of generating a plurality of second modified vectors by modifying a second feature vector outputted from a student network; a loss calculation step of calculating a loss by using the first modified vectors and the second modified vectors; and an optimization step of optimizing parameters of the student network based on the calculated loss.

According to still another aspect of the disclosure, there is provided a network learning system including: a first augmentation unit configured to generate a plurality of first modified vectors by modifying a first feature vector outputted from a teacher network; a second augmentation unit configured to generate a plurality of second modified vectors by modifying a second feature vector outputted from a student network; a first dimension conversion unit configured to convert dimensions of the first modified vectors generated in the first augmentation unit; a second dimension conversion unit configured to convert dimensions of the second modified vectors generated in the second augmentation unit; a loss calculation unit configured to calculate a loss by using the first modified vectors and the second modified vectors the dimensions of which are converted; and an optimization unit configured to optimize parameters of the student network based on the calculated loss.

According to yet another aspect of the disclosure, there is provided a network learning method including: a first augmentation step of generating a plurality of first modified vectors by modifying a first feature vector outputted from a teacher network; a second augmentation step of generating a plurality of second modified vectors by modifying a second feature vector outputted from a student network; a first dimension conversion step of converting dimensions of the first modified vectors generated in a first augmentation unit; a second dimension conversion step of converting dimensions of the second modified vectors generated in a second augmentation unit; a loss calculation step of calculating a loss by using the first modified vectors and the second modified vectors the dimensions of which are converted; and an optimization step of optimizing parameters of the student network based on the calculated loss.

According to embodiments of the disclosure as described above, the effect of learning by knowledge distillation may be enhanced by training the backbone network for visual intelligence like group learning is performed by various teacher networks and student networks, by increasing a feature vector extracted in the teacher network and the student network and calculating a loss.

Other aspects, advantages, and salient features of the invention will become apparent to those skilled in the art from the following detailed description, which, taken in conjunction with the annexed drawings, discloses exemplary embodiments of the invention.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a view provided to explain a learning system of a backbone network for visual intelligence according to an embodiment of the disclosure;

FIG. 2 is a view provided to explain a feature vector modification method;

FIG. 3 is a view provided to explain a loss calculation method; and

FIG. 4 is a view provided to explain a learning system of a backbone network for visual intelligence according to another embodiment of the disclosure.

### DETAILED DESCRIPTION

Hereinafter, the disclosure will be described in more detail with reference to the accompanying drawings.

Embodiments of the disclosure propose a learning method of a backbone network for visual intelligence based on self-supervised learning and multi-head.

The disclosure provides a technology for training a backbone network of a teacher-student structure for visual intelligence like group learning is performed by various teacher networks and student networks, by increasing a feature vector extracted in a teacher network and a student network and calculating a loss.

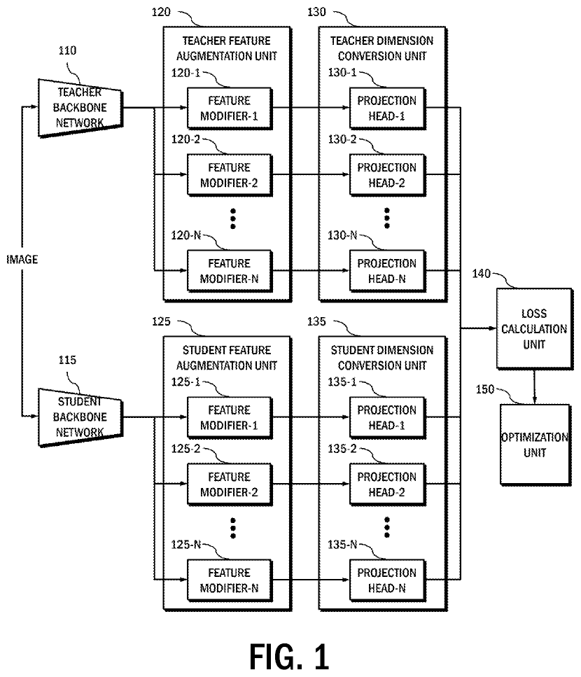

FIG. 1 is a view provided to explain a learning system of a backbone network for visual intelligence according to an embodiment of the disclosure. The learning system according to an embodiment trains a backbone network by a teacher-student learning method which is one of self-supervised learning methods.

As shown in FIG. 1, the learning system according to an embodiment includes a teacher backbone network 110, a teacher feature augmentation unit 120, a teacher dimension conversion unit 130, a student backbone network 115, a student feature augmentation unit 125, a student dimension conversion unit 135, a loss calculation unit 140, and an optimization unit 150.

The teacher backbone network 110 is a pre-trained high-performance backbone network for visual intelligence, and the student backbone network 115 is a backbone network for visual intelligence to be trained. The teacher backbone network 110 and the student backbone network 115 extract a feature vector from inputted image data, and output the feature vector.

The teacher feature augmentation unit 120 increases a feature vector by generating a plurality of modified vectors by modifying the feature vector outputted from the teacher backbone network 110. To perform the above-described function, the teacher feature augmentation unit 120 includes a plurality of feature modifiers 120-1, 120-1, . . . , 120-N. The feature modifiers 120-1, 120-2, . . . , 120-N generate N modified vectors by modifying the feature vector outputted from the teacher backbone network 110 in different methods.

The student feature augmentation unit 125 increases a feature vector by generating a plurality of modified vectors by modifying the feature vector outputted from the student backbone network 115. To perform the above-described function, the student feature augmentation unit 125 includes a plurality of feature modifiers 125-1, 125-2, . . . , 125-N. The feature modifiers 125-1, 125-2, . . . , 125-N generates N modified vectors by modifying the feature vector outputted from the student backbone network 115 in different methods.

The feature modifiers 120-1, 120-2, . . . , 120-N constituting the teacher feature augmentation unit 120 and the feature modifiers 125-1, 125-2, . . . , 125-N constituting the student feature augmentation unit 125 make pairs in modifying the feature vector. Specifically, 1) the feature modifier-1 120-1 of the teacher feature augmentation unit 120 and the feature modifier-1 125-1 of the student feature augmentation unit 125 have the same feature vector modification method, and 2) the feature modifier-2 120-2 and the feature modifier-2 125-2 have the same feature vector modification method, . . . , and N) the feature modifier-N 120-N and the feature modifier-N 125-N have the same feature vector modification method.

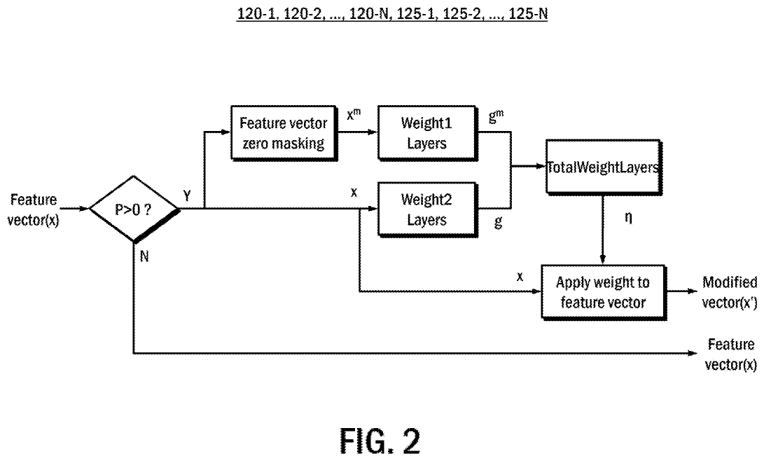

The feature vector modification method will be described in detail below with reference to FIG. 2.

The teacher dimension conversion unit 130 is configured to convert dimensions of the modified vectors generated in the teacher feature augmentation unit 120, and includes a plurality of projection heads 130-1, 130-2, . . . , 130-N. The projection heads 130-1, 130-2, . . . , 130-N may be implemented by multi-layer perceptron (MLP), and may convert dimensions of the modified vectors outputted from the feature modifiers 120-1, 120-2, . . . , 120-N, respectively.

The student dimension conversion unit 135 is configured to convert dimensions of the modified vectors generated in the student feature augmentation unit 125, and includes a plurality of projection heads 135-1, 135-2, . . . , 135-N. The projection heads 135-1, 135-2, . . . , 135-N may be implemented by MLP, and may convert dimensions of the modified vectors outputted from the feature modifiers 125-1, 125-2, . . . , 125-N.

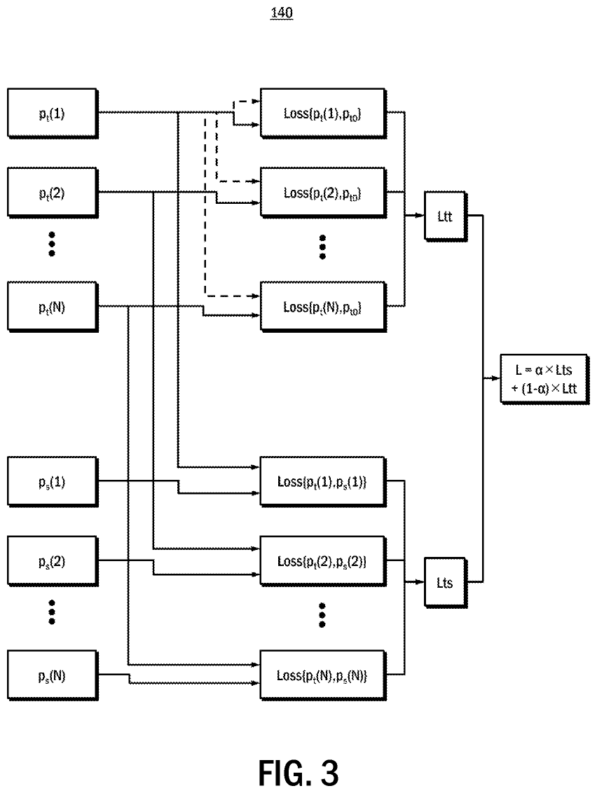

The loss calculation unit 140 calculates a loss by using the N modified vectors the dimensions of which are converted by the projection heads 130-1, 130-2, . . . , 130-N, and the N modified vectors the dimensions of which are converted by the projection heads 135-1, 135-2, . . . , 135-N. A loss calculation method will be described in detail below with reference to FIG. 3.

The optimization unit 150 optimizes parameters of the student backbone network 115 in such a way that the loss calculated by the loss calculation unit 140 decreases.

The feature vector modification method performed by the feature modifiers 120-1, 120-1, . . . , 120-N constituting the teacher feature augmentation unit 120, and the feature modifiers 125-1, 125-2, . . . , 125-N constituting the student feature augmentation unit 125 will be described in detail hereinbelow with reference to FIG. 2.

Since the feature modifiers 120-1, 120-1, . . . , 120-N, 125-1, 125-2, . . . , 125-n have the same algorithm for modifying the feature vector, only one feature modifier is illustrated in FIG. 2.

As shown in FIG. 2, when a feature vector x is inputted from the backbone network 110, 115 at the front end, a masking ratio p is identified. The masking ratio p may be determined by a user for every feature modifier or may be randomly determined. The masking ratio p is the same between the feature modifiers making a pair no matter which method is adopted. That is, 1) the feature modifier-1 120-1 and the feature modifier-1 125-1 have the same masking ratio p, 2) the feature modifier-2 120-2 and the feature modifier-2 125-2 have the same masking ratio p, . . . , and N) the feature modifier-N 120-N and the feature modifier-N 125-N have the same masking ratio p.

When the masking ratio p is 0% (p=0), the feature modifier outputs the feature vector x inputted from the backbone network 110, 115 of the front end as it is without modifying.

On the other hand, when the masking ratio p is larger than 0% (p>0), the feature modifier generates an initial modified vector x^{m} by masking p % feature data out of feature data constituting the feature vector x inputted from the backbone network 110, 115 of the front end with 0 (converting into 0).

In this case, positions of feature data to be masked may be randomly determined, but the masking positions between the feature modifiers constituting a pair should be the same.

The feature modifier determines a weight vector g^{m} to be applied to the initial modified vector x^{m}, and determines a weight vector g to be applied to the feature vector x. The weight vector g^{m} may be generated by passing the initial modified vector x^{m} through Weight Layers which is implemented by an MLP structure, and the weight vector g may be generated by passing the feature vector x through Weight₂Layers which is implemented by an MLP structure, and the weight vector generation process may be expressed by the following equations:

$${g}^{m} = {Weight}_{1} Layers ( {x}^{m} )$$

$$g = {Weight}_{2} Layers ( x )$$

Thereafter, the feature modifier adds up the weight vectors g^{m}, g and then generates a final weight vector n by passing the sum of the weight vectors through TotalWeightLayers which is implemented by an MLP structure. The final weight vector η may constitute TotalWeightLayers to have the same dimension as that of the feature vector x, and the generation process of the final weight vector η may be expressed by the following equation:

$$η = TotalWeightLayers ( {g}^{m} + g )$$

In addition, the feature modifier generates a modified vector x′ by performing elementwise multiplication on the feature vector x and the final weight vector η, and the generation process of the modified vector x′ may be expressed by the following equation:

$${x}^{′} = x ⊗ η$$

Hereinafter, the loss calculation method of the loss calculation unit 140 will be described in detail with reference to FIG. 3. The total loss L may be calculated by the loss calculation unit 140 using the following equation:

$$L = a \times L t s + ( 1 - a ) \times L t t$$

where Lts is a feature vector loss between a teacher and a student, Lit is a feature vector loss between teachers, and a is a weight which is 0.5 or other values.

Lts is an average of losses between the feature/modified vectors (pₜ(i), i=1 to N) outputted from the projection heads 130-1, 130-2, . . . , 130-N at the teacher side, and the feature/modified vectors (pₛ(i), i=1 to N) outputted from the projection heads 135-1, 135-2, . . . , 135-N at the student side which make pairs with those at the teacher side, and may be expressed by the following equations:

$$L t s ( i ) = Loss \{ {p}_{t} ( i ) , {p}_{s} ( i ) \}$$

$$Lts = ( 1 / N ) \times \sum Loss \{ {p}_{t} ( i ) , {p}_{s} ( i ) \}$$

Loss { } may be implemented by Regression loss, Log likelihood, and may be selected by a user. The projection heads 130-1, 130-2, . . . , 130-N, 135-1, 135-2, . . . , 135-N may output the feature vector as it is, or may output the modified vectors. Therefore, vectors outputted from the projection heads are expressed by feature/modified vectors (pₜ(i), pₛ(i)).

Ltt is an average of losses between feature/modified vectors pro outputted from projection heads having the lowest masking ratio p among the projection heads 130-1, 130-2, . . . , 130-N at the teacher side, and the feature/modified vectors (pₜ(i), i=1 to N) outputted from the projection heads 130-1, 130-2, . . . , 130-N at the teacher side, and may be expressed by the following equations:

$$L t t ( i ) = Loss \{ {p}_{t} ( i ) , {p}_{t 0} \}$$

$$Ltt = ( 1 / N ) \times \sum Loss \{ {p}_{t} ( i ) , {p}_{t 0} \}$$

If the lowest masking ratio p is 0%, pₜ₀ is a feature vector, and otherwise, pₜ₀ is a modified vector generated according to a corresponding masking ratio.

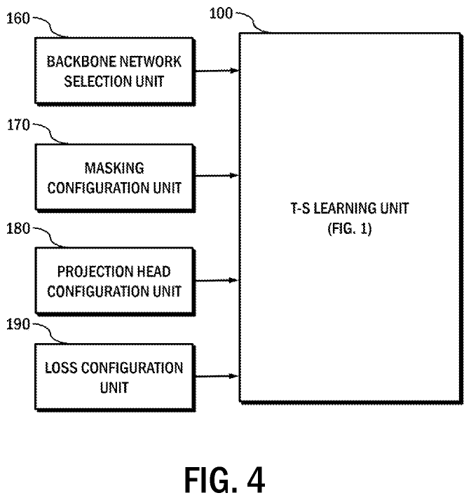

FIG. 4 is a view provided to explain a learning system of a backbone network for visual intelligence according to another embodiment. The learning system according to an embodiment includes a T-S learning unit 100, a backbone network selection unit 160, a masking configuration unit 170, a projection head configuration unit 180, and a loss configuration unit 190.

The T-S learning unit 100 is the learning system of the backbone network for visual intelligence shown in FIG. 1.

The backbone network selection unit 160 is configured to select types of the teacher backbone network 110 and the student backbone network 115 of the T-S learning unit 100. A selectable backbone network may include 1) a convolution-based backbone network such as Resnet, EfficientNet, RegNet, 2) transformer-based backbone network such as Vision Transformer, Swin-Transformer, and other backbone networks.

The masking configuration unit 170 is configured to independently configure masking ratios of the feature modifiers 120-1, 120-2, . . . , 120-N, 125-1, 125-2, . . . , 125-N constituting the feature augmentation units 120, 125.

The projection head configuration unit 180 is configured to configure an MLP structure of the projection heads 130-1, 130-2, . . . , 130-N, 130-1, 130-2, . . . , 130-N constituting the dimension conversion units 130, 135 and to configure dimensions of outputted vectors.

The loss configuration unit 190 is configured to configure a loss function and a weight to be used by the loss calculation unit 140.

Up to now, the learning method and system of the backbone network for visual intelligence based on self-supervised learning and multi-head has been described in detail.

The above-described embodiments propose a method for enhancing the effect of learning by knowledge distillation, by training the backbone network for visual intelligence like group learning is performed by various teacher networks and student networks, by increasing a feature vector extracted in the teacher network and the student network and calculating a loss.

In the above-described embodiments, a training target is limited to the student backbone network, but, in the above-described learning process, the teacher backbone network may be implemented to be trained too. In this case, it is appropriate to apply only Ltt in the loss function, but application of L is not excluded.

In the above-described embodiments, the backbone network which is a training target is an example of a neural network. The technical concept of the disclosure is applicable to a case in which other networks than the backbone network are trained.

The technical concept of the present disclosure may be applied to a computer-readable recording medium which records a computer program for performing the functions of the apparatus and the method according to the present embodiments. In addition, the technical idea according to various embodiments of the present disclosure may be implemented in the form of a computer readable code recorded on the computer-readable recording medium. The computer-readable recording medium may be any data storage device that can be read by a computer and can store data. For example, the computer-readable recording medium may be a read only memory (ROM), a random access memory (RAM), a CD-ROM, a magnetic tape, a floppy disk, an optical disk, a hard disk drive, or the like. A computer readable code or program that is stored in the computer readable recording medium may be transmitted via a network connected between computers.

In addition, while preferred embodiments of the present disclosure have been illustrated and described, the present disclosure is not limited to the above-described specific embodiments. Various changes can be made by a person skilled in the at without departing from the scope of the present disclosure claimed in claims, and also, changed embodiments should not be understood as being separate from the technical idea or prospect of the present disclosure.

What is claimed is:

1. A network learning system comprising:
a first augmentation unit configured to generate a plurality of first modified vectors by modifying a first feature vector outputted from a teacher network;
a second augmentation unit configured to generate a plurality of second modified vectors by modifying a second feature vector outputted from a student network;
a loss calculation unit configured to calculate a loss by using the first modified vectors and the second modified vectors; and
an optimization unit configured to optimize parameters of the student network based on the calculated loss.

2. The network learning system of claim 1, wherein the first augmentation unit comprises first modifiers configured to generate the plurality of first modified vectors by applying different modification methods to the first feature vector,
wherein the second augmentation unit comprises second modifiers configured to generate the plurality of second modified vectors by applying different modification methods to the second feature vector, and
wherein the first modifiers and the second modifiers are configured to make pairs and apply a same modification method.

3. The network learning system of claim 2, wherein the first modifiers are configured to generate the first modified vectors by masking a part of feature data constituting the first feature vector with zero, and
wherein the second modifiers are configured to generate the second modified vectors by masking a part of feature data constituting the second feature vector with zero.

4. The network learning system of claim 3, wherein the first modifiers and the second modifiers are configured to mask a number of pieces of feature data determined according to pre-set masking ratios with zero, respectively.

5. The network learning system of claim 4, wherein the masking ratios are configured by a user or randomly configured, and
wherein positions of feature data to be masked with zero are randomly determined.

6. The network learning system of claim 3, wherein the first modifier is configured to generate a first weight vector from the first modified vector, to generate a second weight vector from the first feature vector, to generate a final weight vector by adding up the first weight vector and the second weight vector, and to generate a final first modified vector by calculating the first feature vector and the final weight vector, and
wherein the second modifier is configured to generate a first weight vector from the second modified vector, to generate a second weight vector from the second feature vector, to generate a final weight vector by adding up the first weight vector and the second weight vector, and to generate a final second modified vector by calculating the second feature vector and the final weight vector.

7. The network learning system of claim 2, wherein the loss calculation unit is configured to calculate an average of differences between the first modified vectors and the second modified vectors as a loss.

8. The network learning system of claim 7, wherein the loss calculation unit is configured to further calculate an average of differences between a first modified vector having smallest modification among the first modified vectors, and the first modified vectors, as a loss.

9. The network learning system of claim 2, further comprising:
a first dimension conversion unit configured to convert dimensions of the first modified vectors generated in the first augmentation unit; and
a second dimension conversion unit configured to convert dimensions of the second modified vectors generated in the second augmentation unit.

10. A network learning method comprising:
a first augmentation step of generating a plurality of first modified vectors by modifying a first feature vector outputted from a teacher network;
a second augmentation step of generating a plurality of second modified vectors by modifying a second feature vector outputted from a student network;
a loss calculation step of calculating a loss by using the first modified vectors and the second modified vectors; and
an optimization step of optimizing parameters of the student network based on the calculated loss.

11. A network learning system comprising:
a first augmentation unit configured to generate a plurality of first modified vectors by modifying a first feature vector outputted from a teacher network;
a second augmentation unit configured to generate a plurality of second modified vectors by modifying a second feature vector outputted from a student network;
a first dimension conversion unit configured to convert dimensions of the first modified vectors generated in the first augmentation unit;
a second dimension conversion unit configured to convert dimensions of the second modified vectors generated in the second augmentation unit;
a loss calculation unit configured to calculate a loss by using the first modified vectors and the second modified vectors the dimensions of which are converted; and
an optimization unit configured to optimize parameters of the student network based on the calculated loss.
